(19) United States
(12) Patent Application Publication
(10) Pub. No.: US 2004/0182884 A1
(43) Pub. Date: Sep. 23, 2004

(54) Auxiliary cover for pump dispenser and vessel attached with pump dispenser

(76) Inventor: Tetsuya Tada, Tokyo (JP)

Correspondence Address: FLYNN THIEL BOUTELL & TANIS, P.C., 2026 RAMBLING ROAD, KALAMAZOO, MI, 49008-1699, US

(21) Appl. No.: 10/815,599

(22) Filed: Apr. 1, 2004

(30) Foreign Application Priority Data
Sep. 11, 2002 (JP) 2002-266135

(51) Int. Cl. B67D 5/60

(52) U.S. Cl. 222/153.13

(57) ABSTRACT

There is provided an auxiliary cover which can improve the operability at the time of issuing liquid from a pump dispenser. The auxiliary cover for a pump dispenser which is attached on the pump dispenser for issuing liquid in a vessel with an upward and downward movement of the nozzle head and which has a function of pressing the nozzle head in a downward direction with a lever portion, wherein the cover can be attached on a cap of the pump dispenser. The auxiliary cover for this pump dispenser has a hollow-shaped base portion and is rotatably provided on the base portion via a hinge. The auxiliary cover presses the nozzle head in a downward direction with the rotation of the lever portion.

### TECHNICAL FIELD

The present invention relates to an auxiliary cover for a pump dispenser which cover is attached on the pump dispenser for issuing each kind of liquid or the like.

More particularly, the invention relates to an auxiliary cover which is attached on the pump dispenser and has a function of pressing a nozzle head in a downward direction.

### RELATED ART

Conventionally, a pump dispenser for issuing a liquid in a vessel with an upward and a downward movement of a nozzle head is used in many cases.

Such pump dispenser is attached on an opening part of the vessel which is filled with liquid and is used. The pump dispenser can display a function of issuing (spraying is also included therein) liquid from the nozzle by compressing the liquid in the cylinder which is absorbed up from the vessel with the downward movement of a piston having a nozzle head which moves in an upward and a downward movement.

Generally, in order to issue the liquid, an operation is required for grasping the pump dispenser with hands and pressing the nozzle head from above in a downward direction by the use of fingers or the like.

For this purpose, for example, in the case where the pump dispenser is used as a spray for residential use, a pressing operation becomes difficult depending on a location to be sprayed or a posture of spraying the liquid.

Furthermore, in the case where the pump dispenser is used as a recent spray for cosmetics, the nozzle port is shifted in an attempt of pressing down the nozzle head from above at the time of blowing the front side (the face side) by holding the pump dispenser with the hand. Thus, the operation thereof is difficult.

Namely, this means that the pressure can be hardly applied and the position of the nozzle cannot be stably held.

From the above fact, a pump dispenser is developed which is constituted in such a manner that the nozzle head can be easily pressed in a downward direction only by attaching a cover on a piston up and down style pump dispenser so as to press the nozzle head from the horizontal direction.

As one example, there is provided an easy trigger style liquid issuing vessel or the like (for example, see Patent Literature 1).

This easy trigger style liquid issuing vessel uses an auxiliary cap which enables changing the power direction. The auxiliary cap can be strongly attached on the vessel by fitting a projecting portion of the main body of the cap (corresponding to the cover) into a recessed groove formed on the inlet of the vessel.

Then, the liquid in the vessel can be issued by easily pressing the horizontal plate onto the head through the triggering of the bent plate member of the main body of the cap.

That is, in the conventional pump dispenser of this type, the head can be easily pressed down by pulling the trigger in a horizontal direction by the use of the main body of this cap.

In this manner, since a power in a horizontal direction becomes power in a vertical direction (namely, in a downward direction) with a bent plate member, a manual operation becomes extremely easy and useful.

[Patent Literature 1]

Japanese Unexamined Patent Publication No. Hei 9-57163

However, the liquid issuing vessel attached with the conventional pump dispenser, a problem arises in the case where the vessel is filled with liquid.

In the case where the vessel is refueled with liquid, it is required to unscrew the neck of the opening part to temporarily detach the pump dispenser from the main body of the vessel. In the pump dispenser of this form, in the beginning, the attachment tube cannot be unscrewed unless the main body of the cap has been detached from the neck of the opening part.

Furthermore, on the contrary, in the case where the pump dispenser is attached, the main body of the cap is attached on a neck of the opening part of the vessel after the attachment cylinder is screwed and attached on the neck of the opening part thereof.

In this manner, both the main body of the cap and the attachment cylinder must be attached on the vessel or detached therefrom. Thus, the operation becomes complicated and very troublesome, which means that the efficiency of the liquid refuel is unfavorable. That is, there is a problem in that the detachment of the main body of the cap and the attachment thereof cannot be accomplished at one time and must be performed in two different processes of work, and the operability is unfavorable.

Furthermore, with the conventional dispenser, there arises a problem in that force is applied also in the rotation direction of the nozzle when force is applied to move the nozzle head in the upward and downward movement of the nozzle head with the result that the nozzle is rotated so that the liquid cannot be sprayed to a predetermined location.

Furthermore, with the conventional pump dispenser, the trigger is pulled unintentionally so that the liquid is issued from the nozzle in some cases. In order to avoid this, a nozzle cap must be attached on the nozzle when the pump dispenser is not used with the result that such process is troublesome and the nozzle cap is lost.

### SUMMARY OF THE INVENTION

The present invention has been made against such background. The present invention has been made to overcome the aforementioned problem.

That is, an object of the present invention is to provide an auxiliary cover for a pump dispenser which is capable of improving the operability at the time of issuing the liquid from the pump dispenser.

Thus, after a deliberate study against such background of the problem, the inventors of the present invention has found that the aforementioned problem can be solved by directly attaching the auxiliary cover on a cap which is a part of the pump dispenser. On the basis of such study, the present invention was completed.

That is, the gist of the present invention lies in (1) an auxiliary cover for a pump dispenser which is attached on the pump dispenser for issuing liquid in a vessel with the upward and the downward movement of the nozzle head and which has a function of pressing the nozzle head in a downward direction to a point lower than the lever portion.

Furthermore, the gist of the present invention lies in that (2) a projection or a groove is formed on an upper end of the aforementioned nozzle head, and is engaged with a groove or a projection formed on the rear side of the lever portion.

Furthermore, the gist of the present invention lies in that (3) a hollow base portion attached on the aforementioned cap is provided thereon and the aforementioned lever portion is rotatably provided via a hinge portion on the base portion with the result that the nozzle head is pressed in a downward direction with the rotation of the lever portion.

Furthermore, the gist of the present invention lies in that (4) the aforementioned base portion has a notch portion which allows the movement of a nozzle projecting from the nozzle head.

Furthermore, the gist of the present invention lies in that (5) the aforementioned base portion has a notch portion which allows the movement of the nozzle which projects from the nozzle head and the rotation of the lever portion, and the lever portion hangs down to the side opposite to the nozzle.

Furthermore, the gist of the present invention lies in that (6) the aforementioned base portion has a notch portion which allows the movement of the nozzle which projects from the nozzle head and the rotation of the lever portion, and the lever portion has a notch portion which allows the movement of the nozzle and hangs down to the side same as the nozzle.

Furthermore, the gist of the present invention lies in that (7) the base portion and the lever portion are integrated via the hinge portion.

Furthermore, the gist of the present invention lies in that (8) a stopper separable for preventing the rotation of the lever portion is provided between the aforementioned base portion and the lever portion.

Furthermore, the gist of the present invention lies in that (9) a projection piece provided on the aforementioned lever portion presses an upper surface of the nozzle head.

Furthermore, the gist of the present invention lies in that (10) a cylinder-shaped safety member attached with the a rotation stopper rotatable between a position of restraining the movement of the aforementioned lever and an open position of not restraining the movement is provided in such a manner that the member has a center shaft which is the same as the center shaft of the base portion.

Furthermore, the gist of the present invention lies in that (11) a stopper holding portion is formed on the aforementioned safety member for holding the rotation stopper at the open position.

Furthermore, the gist of the present invention lies in that (12) the aforementioned stopper holding portion is formed of a plate-like member and is sandwiched between the pair of the plate-like member to be held.

Furthermore, the gist of the present invention lies in that (13) a support piece for receiving a thumb is provided on the aforementioned safety member on the side opposite to the side on which the rotation stopper is formed, so that a vessel attached with the gripped pump dispenser does not slips down.

Furthermore, the gist of the present invention lies in that (14) the aforementioned safety member is integrated with the base portion.

Furthermore, the gist of the present invention lies in that (15) an auxiliary cover for the pump dispenser according to any one of claims 1 through 14 is provided.

Incidentally, a structure of an appropriate combination of the aforementioned claims can be adopted when such structure suits the object of the present invention.

According to the present invention, operability can be improved at the time of issuing liquid from the pump dispenser.

### BRIEF DESCRIPTION OF THE DRAWINGS

FIG. 1 is an external appearance view showing a state in which an auxiliary cover according to Embodiment 1 is attached on a pump dispenser;

FIG. 2 is a sectional view taken along line A-A of FIG.

FIG. 3 is an explanatory view showing an end side of a nozzle head, wherein FIG. 3(A) is an enlarged view showing an end side of the nozzle head of FIG. 2, and FIG. 3(B) is a sectional view taken along line B-B of FIG. 3(A);

FIG. 4 is an explanatory view showing a state after a lever portion has been rotated;

FIG. 5 is a sectional view including an auxiliary cover according to Embodiment 2;

FIG. 6 is an explanatory view showing a state after a lever portion has been rotated;

FIG. 7 is a sectional view showing an auxiliary cover according to Embodiment 3, wherein FIG. 7(A) is a view showing the auxiliary cover for cosmetics use, and FIG. 7(B) is a view showing the residential use;

FIG. 8 is a perspective view showing a safety member;

FIG. 9 is a sectional view including an auxiliary cover on which the safety member is provided;

FIG. 10 is an explanatory view showing a method of hooking a finger at the time of operating the dispenser of FIG. 9; and

FIG. 11 is a view showing a variation of a stopper.

### DESCRIPTION OF THE PREFERRED EMBODIMENTS

Hereinafter, the most preferable form for embodying the present invention will be explained by referring to the drawings.

First Embodiment

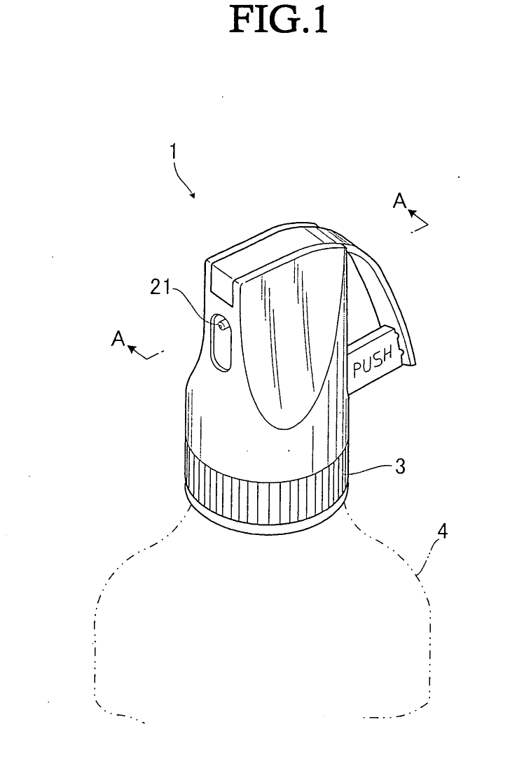

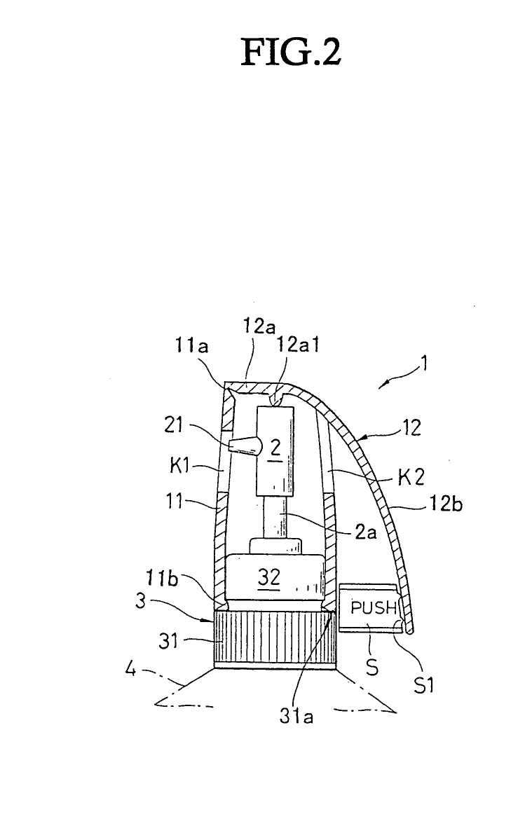

FIG. 1 is a view showing a state in which an auxiliary cover attached with the pump dispenser according to Embodiment 1 is provided on a vessel attached with the dispenser. Furthermore, FIG. 2 is a sectional view taken along line A-A of FIG. 1.

The auxiliary cover 1 is primarily used for cosmetics (for the human body). The cover is used in such a manner that the nozzle 21 thereof is directed to the front side (the side of the human body) to blow the liquid to the face or the like.

In the beginning, there will be briefly explained a pump dispenser. The pump dispenser comprises a cap 3, a nozzle head 2, and a piston shaft 2a (a piston not shown is provided therebelow) which is attached on the lower end of the nozzle head 2 and a cylinder not shown.

Furthermore, the piston shaft 2a is attached in such a manner that the piston shaft 2a can be moved with respect to the cap 3 which should be originally attached on the main body of the vessel 4.

The piston shaft 2a is lowered by pressing down the nozzle head 2 to compress the liquid in the cylinder to issue fog-like liquid from the nozzle 21 of the nozzle head 2.

Here, the nozzle 21 has an issue port on the end thereof, and is provided in a projecting manner from the nozzle head 2.

Such pump dispenser can be constituted in such a manner that liquid in the vessel can be set in the state of easily issued by attaching (normally screwing) the cap 3 on opening part of the main body of the vessel 4.

The cap 3 comprises a large diameter portion 31 and a small diameter portion 32 which is integrally provided on the large diameter portion 31. On the external side of the small diameter portion 32, the auxiliary cover 1 is attached from above, so that the opening part of the vessel is screwed onto the inside of the large diameter portion 31.

In the case where the liquid in the vessel ceases to be consumed, liquid is refueled by detaching the cap 3 of the pump dispenser from the opening part of the vessel.

Next, the auxiliary cover 1 will be explained in detail. The auxiliary cover 1 comprises a hollow-shaped base portion 11 and a lever portion 12 which extends in a bent-like configuration from a part thereof.

The base portion 11 is formed in a hollow-shaped configuration in such a manner that the base portion 11 can embrace the nozzle head 2. Furthermore, the base portion 11 has a notch portion K2 at a rear location (the right side in the drawing) so as to allow the rotation of the lever portion 12.

Furthermore, the lever portion 12 is formed in a long configuration and has a horizontal portion 12a and a hanging portion 12b which extends in a downward direction to a location lower than the horizontal portion 12a.

The lever portion 12 is integrated a thin connection portion, specifically, the base portion 11, on a part (an upper part here) via a hinge portion 11a. Consequently, the lever portion 12 can be rotated in a downward direction on this hinge portion 11a.

When the lever portion 12 is rotated, the horizontal portion 12a is lowered in a downward direction. Consequently, the lever portion 12 acts in a manner of pressing an upper surface of the nozzle head 2 because the horizontal portion 12a is lowered in a downward direction.

It is preferable that a projection piece 12a1 is formed for pressing the nozzle head 2 on the rear surface of the horizontal portion 12a from the viewpoint of the mutual force transmission between projection piece 12a1 and the nozzle head 2.

A stopper S (which is referred to as a virgin seal) is provided between the lever portion 12 and the base portion 11. This stopper S is integrated with the lever portion 12 via a thin portion S1.

Incidentally, the stopper S is not integrated with the base portion 11.

Consequently, even if an attempt is normally made to pull the lever portion 12, this stopper S standing in the way will not move with the result that liquid will not be issued unintentionally.

This stopper S is separated and detached from the portion of the thin portion S1 at the time of usage so that the lever portion 12 can be rotated.

By the way, the auxiliary cover 1 is attached on the cap 3 of the pump dispenser and is used. In the pump dispenser in which the nozzle head 2 is moved in an upward and downward direction, as described above, the nozzle 21 is formed in a horizontal direction from the nozzle head 2 in a projecting configuration.

Needless to say, the base portion 11 of the auxiliary cover 1 a notch portion k1 which is a long hole for allowing the movement in order to move this nozzle 21 in an upward and a downward direction together with the upward and downward movement of this nozzle head 2.

Here, the nozzle 21 is not projected from the notch portion K1. However, it goes without saying that a structure in which the nozzle is projected largely from the notch portion K1 can be adopted.

In the presence of the notch portion K1 formed on the base portion 11 and the notch portion K2 which has been described above, the lever portion 12 and the nozzle 21 can be moved in an upward and a downward direction without any difficulty.

By the way, the lower portion of the auxiliary cover 1 can be extrapolated to the small diameter portion 32 of the cap 3, and is attached thereon by strongly pressing the auxiliary cover 1 against the cap 3.

More preferably, at that time, when a recessed groove 31a is provided on the neck portion of the large diameter portion 31 for fitting an internal projection 11b of the lower end portion of the auxiliary cover 1, both the auxiliary cover 1 is hardly detached from the cap 3.

By the way, the pump dispenser is attached on the main body of the vessel 4. Furthermore, it is supposed that the auxiliary cover 1 of the present invention is attached on the cap 3 of the pump dispenser (see FIG. 2).

At the time of usage, a stopper S for preventing the rotation of the lever portion 12 is separated from the thin portion S1 and detached therefrom.

Thus, the pump dispenser can be set in a usable state. From this state, for example, there is considered a case in which the liquid in the vessel is issued toward the face to be blown thereto.

In the beginning, the auxiliary cover 1 is grasped with the hand in the state the nozzle 21 is directed toward the face, so that the lever portion 12 (a hanged portion 12b in detail) is pulled with a finger.

Consequently, the lever portion 12 is rotated clockwise on the hinge portion 11a.

With the rotation of the lever portion 12, this horizontal portion 12a acts in a manner of pressing down the upper surface of the nozzle head 2.

The piston shaft 2a which is integrated with the nozzle head 2 is lowered, so that the liquid in the cylinder can be compressed to issue a foam-like liquid from the nozzle 21.

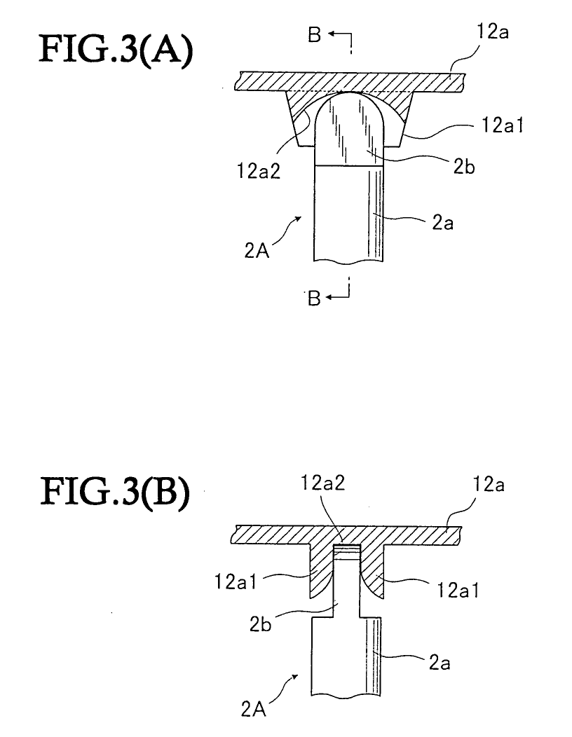

FIG. 3 is a view showing a variation of the nozzle head 2 of FIG. 2. FIG. 3(A) is a view showing an end side of the nozzle head. FIG. 3(B) is a sectional view taken along line B-B of FIG. 3(A).

As shown in FIG. 3, on the end of the nozzle head 2A, a plate-like projection portion 2b is formed which has a rounded end.

This projection portion 2b is engaged with a groove 12a 2 formed with the pair of projection piece 12a1 formed on the horizontal portion 12a.

Consequently, when the lever portion 12 is pulled in order to issue liquid, the nozzle head 2A is prevented from being rotated unintentionally.

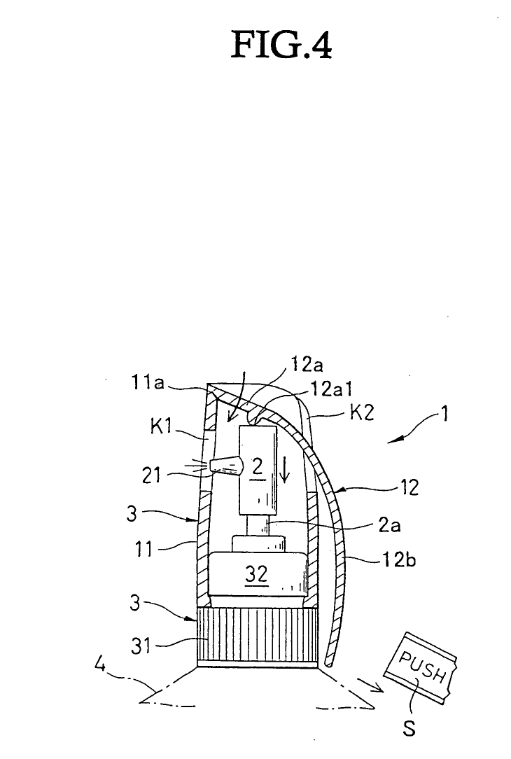

FIG. 4 is a view showing a state after the lever portion 12 is rotated.

In this case, on the base portion 11, the notch portion K1 and the notch portion K2 are formed with the result that the lever portion 12 can be rotated and the nozzle head 2 can be moved in a downward direction with ease.

After the liquid is issued, the nozzle head 2 is lifted with the return force by separating the finger from the lever portion 12 or loosening the force of the finger with the result that the nozzle head is brought back to the original state.

In this manner, the liquid can be issued toward the front by grasping the auxiliary cover 1 in a comfortable manner so that the cover is extremely useful for cosmetics use.

By the way, there is considered a case in which liquid in the vessel is consumed, so that new liquid is refueled.

At the time of detachment of the pump dispenser, the cap 3 may be simply held with the hand, so that the cap 3 is unscrewed from the opening part of the main body of the vessel 4.

At the time of attachment of the pump dispenser after refueling the liquid, the cap 3 may be simply held with the hand, so that the cap 3 is unscrewed from the opening part of the main body of the vessel 4.

In this manner, the attachment and the detachment of the cap can be easily performed at one time, which means that the operation can be performed in a simple one-time process of work and the operation is very convenient.

Second Embodiment

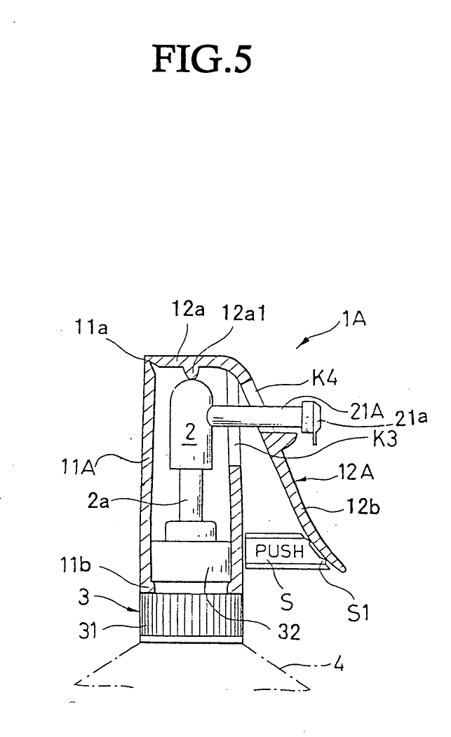

FIG. 5 is a sectional view showing a cross section of the auxiliary cover attached with the pump dispenser according to Second Embodiment of the present invention.

This auxiliary cover 1A is primarily applied to a pump dispenser for residential (member) use. The auxiliary cover 1A is used by directing, for example, the nozzle 21A toward the side of the wall.

Embodiment 2 is the same as Embodiment 1 in that the auxiliary cover 1A comprises a hollow-shaped base portion 11A which can embrace the nozzle head 2 and a lever portion 12A which extends in a bent-like configuration from the base portion 11A. On the side of the lever portion of the base portion 11A, a notch portion K3 is formed for allowing the upward and the downward movement of the nozzle 21A.

Here, this notch portion K3 has a function of the notch portion for allowing the upward and the downward movement of the nozzle 21A.

Furthermore, on the lever portion 12A, a long hole is formed which is a notch portion K4 for allowing the upward and downward movement of the nozzle 21A.

In the presence of these notch portions K3 and K4, the nozzle 21A and the lever portion 12A can be moved in an upward and a downward direction with no difficulty.

By the way, the pump dispenser is now attached on the main body of the vessel 4 and the auxiliary cover 1A of the present invention is attached on the cap 3 of the pump dispenser (see FIG. 5).

As has been described above, at the time of usage, the stopper S that prevents the rotation of the lever portion 12A is removed. Furthermore, the squirt hole is exposed and can be used by opening the hinge lid 21a of the nozzle 21A.

In the case where the liquid in the vessel issued and blown toward the wall surface, the nozzle 21A is directed to the wall surface in the beginning, followed by grasping the auxiliary cover 1A with the hand to pull the lever portion 12A with a finger.

The lever portion 12A rotates clockwise on the hinge portion 11a. With the rotation of this lever portion 12A, the horizontal portion 12a acts in a manner of pressing down the upper surface of the nozzle head 2.

The piston shaft 2a which is integrated with the nozzle head 2 is lowered to compress the liquid in the cylinder (not shown) to be issued from the nozzle 21A

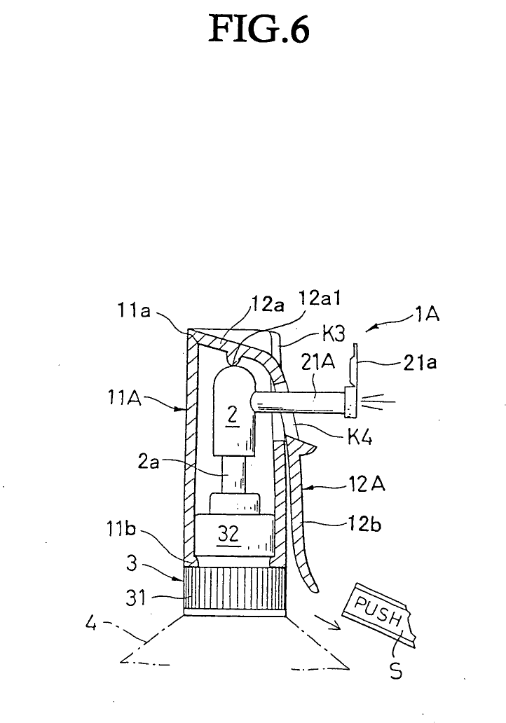

FIG. 6 is a view showing a state in which the lever portion 12A has been rotated. Since the notch portion K3 and the notch portion K4 are formed on the base portion 11A and the lever portion 12A, the downward movement of the nozzle head 2 and the rotation of the lever portion 12A are smoothly performed without any difficulty.

Thereafter, the nozzle head 2 rises with the retraction force by separating the finger from the lever portion 12A or loosening the force of the finger.

In this manner, the liquid can be issued to the side opposite to the front and is extremely useful for use in the residential use.

By the way, in the case where new liquid is refueled, as has been described in Embodiment 1, the attachment and detachment of the pump dispenser can be performed at one time in a single operation and it is extremely useful.

Third Embodiment

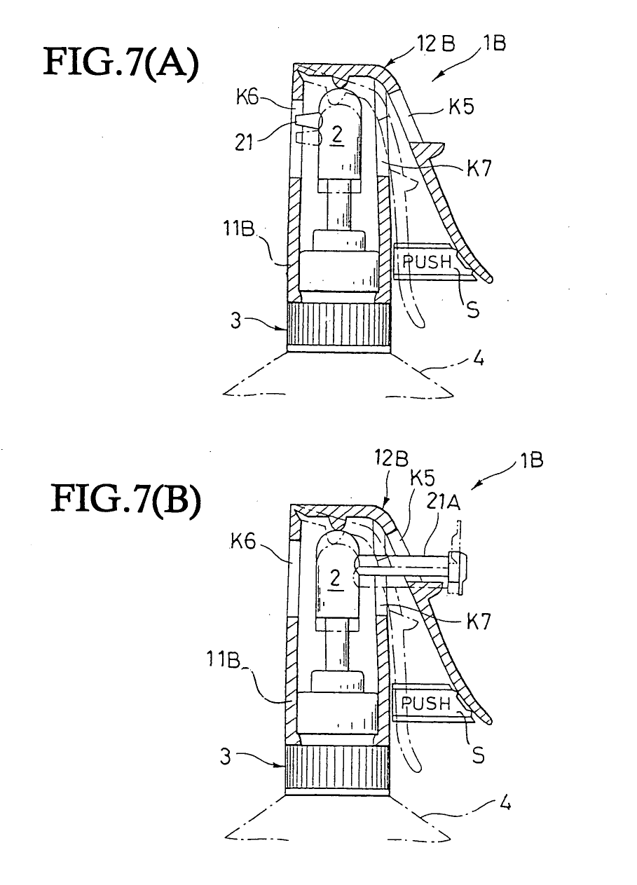

As shown in FIG. 7, this auxiliary cover 1B can be applied both to the cosmetic use [see FIG. 7(A)] and to the residential use [see FIG. 7(B)].

That is, a long hole is formed which is a notch portion K5 on the lever portion 12B. A long hole which is a notch portion K6 is formed on the front side of the base portion 11B. Furthermore, on the rear side thereof (on the right side thereof), a notch portion K7 is formed.

Consequently, when the size of the cap 3 is the same, the auxiliary cover can be applied even if the positions of the nozzles 21 and 21A of the pump dispenser are formed either on the front or the rear side. The cover can be used both for the cosmetics use and for the residential use, so that the cover can be universally used.

Other Embodiments

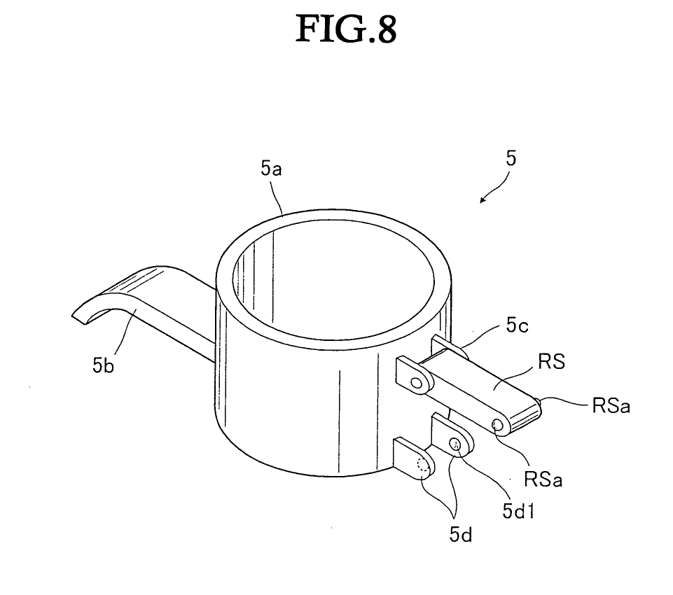

In the present invention, a safety member 5 as shown in FIG. 8 can be used.

This safety member 5 secures the safety of operation at the time of using the pump dispenser. The safety member 5 can be selectively provided on the auxiliary cover 1 to function.

The safety member 5 has a hollow cylindrical main body portion 5a and a support piece 5b which is formed therefrom in a projecting manner.

Furthermore, the safety member 5 has a support portion 5c provided on the side opposite to the support piece 5b to rotatably hold the rotation stopper RS, and a stopper housing portion 5d for holding the rotation stopper RS at an open position.

The safety member 5 is provided on the periphery of the base portion 11 of the auxiliary cover 1, and the safety member can be fixed with certitude by the pressure-in thereof into the base portion 11 or by the use of the adhesive.

Otherwise, it is possible to integrally form the safety member 5 and the auxiliary cover 1 with synthetic resin.

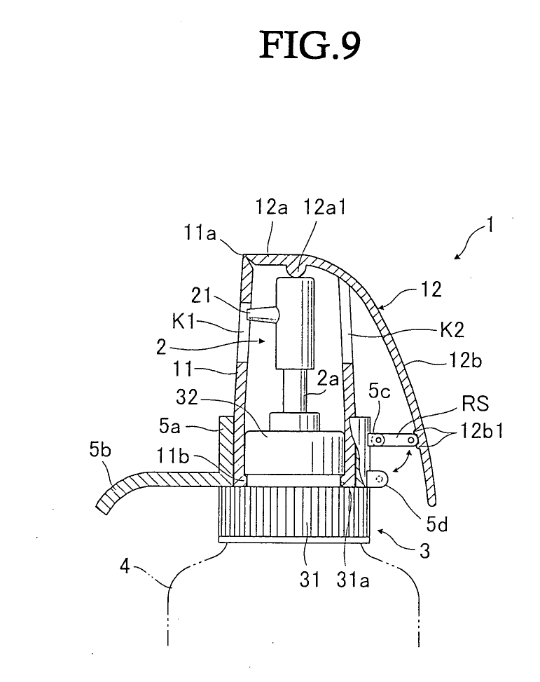

In the state in which the safety member 5 is attached on the cylindrical main body portion 5a (see FIG. 9), the support piece 5b comes into contact with the thumb to support the weight thereof with ease in the case of lifting the whole vessel together with the pump dispenser for issuing the liquid.

On the other hand, the rotation stopper RS provided on the side opposite to the support piece 5b can be appropriately shifted from a position of restraining the movement of the lever portion 12 and the position of opening the lever portion 12.

At the restraining position, the rotation stopper RS is set in approximately horizontal state to restrain (prevent) the rotation of the lever portion 12 with the result that unintentional erroneous operation can be prevented and the operation is safe.

Furthermore, at an open position, the rotation stopper RS is formed in approximately vertical state, so that the lever portion 12 can be rotated.

The aforementioned stopper housing portion 5d is formed of a pair of mutually adjacent plate-like members. Between the plate-like members, the rotation stopper RS is sandwiched and the stopper RS is held in a detachable manner.

The holding force can be increased with certitude by engaging the projection RSa of the rotation stopper RS with the hole portion 5d1 formed on the pair of plate-like portions.

In the case where the safety member 5 is provided on the auxiliary cover 1 in this manner, the operation in more safe state is enabled.

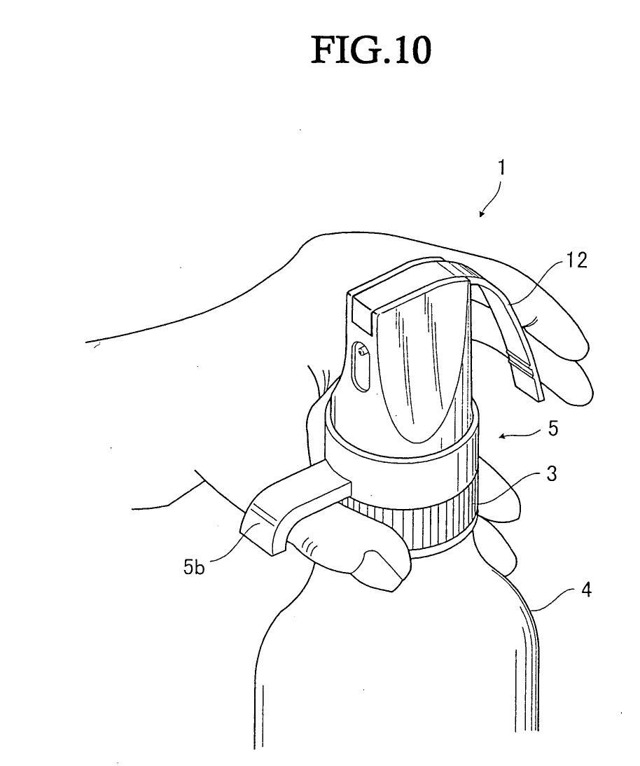

That is, when the pump dispenser is used, as shown in FIG. 10, the index finger and the middle finger are applied to the lever portion 12 and the ring finger, little finger are applied to the vicinity of the cap in the state in which the thumb is allowed to come into contact with the lower portion of the support piece 5b to support the whole vessel.

Then, after the rotation stopper RS is allowed to be knocked down to be set in an open state, the rotation stopper RS is rotated by pressing down the lever portion 12 with the index finger and the middle finger. Thus, the liquid can be easily issued from the nozzle.

In the case where no support piece 5b is provided, a strong grasping force is required between the thumb, and index finger and the middle finger so as to support the whole vessel. Thus there is a possibility that the lever portion 12 is erroneously rotated.

However, in the case where the support piece 5b is provided, a strong grasp force is not required because the weight of the whole vessel can be supported with the thumb with the result that such case will not be generated.

Then, the safety member 5 is attached on the base portion 11 with the extrapolation of the main body portion 5a onto the base portion 11 (see FIG. 9).

So far, the present invention has been explained above. However, the present invention is not limited thereto. Various variations can be made within the scope of the present invention.

For example, the configuration of the nozzle heads 2, 2A can be formed in various configurations. From this fact, the contact state with the lever portions 12, 12A and 12B can be changed.

Furthermore, the position of the hinge portion 11a can be changed which forms a location where the base portion 11 and the lever portions 12, 12a and 12B are mutually connected to each other.

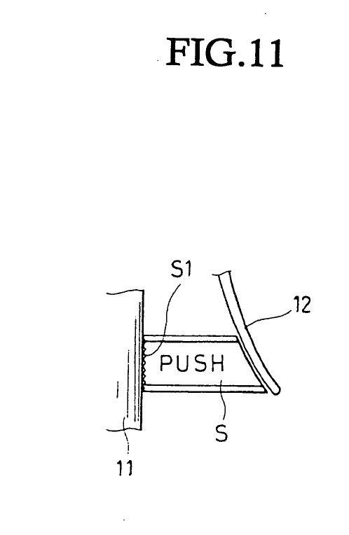

Furthermore, there is also shown a state in which the stopper S is integrated with the lever portions 12, 12A, and 12B. As shown in FIG. 11, the stopper S can be integrated with the base portion 11 via a thin portion.

Incidentally, the lever portion 12 and the stopper S are not integrated in this case.

Furthermore, it is possible to integrate the base portion 11 and the lever portion 12 with the stopper S via thin portions.

Furthermore, it is possible to change the configuration of the rotation stopper RS and the stopper housing portion 5d within the scope of giving full scope to the ability thereof.

What is claimed is:

1. An auxiliary cover for a pump dispenser which is attached on the pump dispenser for discharging liquid in a vessel with an upward and a downward direction of a nozzle head, the cover having a function of pressing down the nozzle head with a lever portion, characterized in that the cover is attached on a cap of the pump dispenser.

2. The auxiliary cover for the pump dispenser according to claim 1, characterized in that a projection or a groove is formed on an upper end of the nozzle, and the projection or the groove is engaged with a groove or a projection formed on the rear side of the lever portion.

3. The auxiliary cover for the pump dispenser according to claim 1, comprising:
a base portion having a hollow-shaped configuration which is attached on the cap;
characterized in that the lever portion is rotatably provided on the base portion via a hinge portion, and the nozzle portion is pressed in a downward direction with the rotation of the lever portion.

4. The auxiliary cover for the pump dispenser according to claim 3, characterized in that the base portion has a notch portion which allows the movement of the nozzle which projects from the nozzle head.

5. The auxiliary cover for the pump dispenser according to claim 3, characterized in that the base portion has a notch portion which allows the movement of the nozzle which projects from the nozzle head, and a notch portion which allows the rotation of the lever portion, and the lever portion hangs down to the side opposite to the nozzle.

6. The auxiliary cover for the pump dispenser according to claim 3, wherein the base portion has a notch portion which allows the movement of the nozzle and the rotation of the lever portion, and the lever portion has a notch portion which allows the movement of the nozzle, and hang down to the same side as the nozzle.

7. The auxiliary cover for the pump dispenser according to claim 3, characterized in that the base portion and the lever portion are integrated via the hinge portion.

8. The auxiliary cover for the pump dispenser according to claim 3, wherein a separable stopper is provided for preventing the rotation of the lever portion between the base portion and the lever portion.

9. The auxiliary cover for the pump dispenser according to claim 3, wherein the projection piece provided on the lever portion presses the upper surface of the nozzle head.

10. The auxiliary cover for the pump dispenser according to claim 3, wherein a cylinder-shaped safety member attached with a rotation stopper which can be rotated at a position of restraining the movement of the lever portion and an open position of not restraining the movement thereof is provided in such a manner that a center shaft is provided identical to the center shaft of the base portion.

11. The auxiliary cover for the pump dispenser according to claim 10, wherein a stopper holding portion is formed on the safety member for holding the rotation stopper at the open position.

12. The auxiliary cover for the pump dispenser according to claim 11, wherein the stopper holding portion is formed of a pair of mutually adjacent plate-like members, and the rotation stopper is held and sandwiched between the pair of the plate-like members.

13. The auxiliary cover for the pump dispenser according to claim 10, wherein a support piece is provided for receiving a thumb so that a vessel attached with the grasped pump dispenser is not slipped to the side opposite to the side on which the rotation stopper is formed.

14. The auxiliary cover for the pump dispenser according to claim 10, wherein the safety member is integrated with the base portion.

15. A vessel attached with a pump dispenser having the auxiliary cover for the pump dispenser according to any one of claims 1 through 14.
